(19) United States
(12) Patent Application Publication
(10) Pub. No.: US 2005/0174187 A1
(43) Pub. Date: Aug. 11, 2005

(54) Non-reciprocal circuit device including multilayer board

(75) Inventors: Isao Ishigaki, Fukushima-ken (JP); Hitoshi Onishi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/050,579

(22) Filed: Feb. 3, 2005

(30) Foreign Application Priority Data
Feb. 6, 2004 (JP) 2004-031092

(51) Int. Cl. H01P 1/32

(52) U.S. Cl. 333/1.1; 333/24.2

(57) ABSTRACT

A non-reciprocal circuit device includes a dielectric that is a multilayer board in which a plurality of insulating sheets are laminated; a first central conductor, a second central conductor, and a third central conductor that are disposed in different layers of the dielectric, and are arranged vertically such that they partially cross one another; a flat ferrite member disposed on the undersurface of the dielectric; a first capacitor, a second capacitor, and a third capacitor that are disposed on the undersurface of the dielectric; and a case for accommodating the ferrite member. The dielectric with the central conductors, the ferrite member, and the capacitors are integrated together to form a half-finished product, which is then placed in the case.

### BACKGROUND OF THE INVENTION

1. Field of the Invention

The present invention relates to non-reciprocal circuit devices, such as isolators and circulators, that are applied to, for example, a transmitting part of mobile communication systems, such as mobile phones. The present invention also relates to a method for producing the non-reciprocal circuit devices.

2. Description of the Related Art

FIG. 14 is an exploded perspective view of a known non-reciprocal circuit device, which will be described below. Referring to FIG. 14, the known non-reciprocal circuit device includes a box-shaped first yoke 51 formed of magnetic plates (such as iron plates). A disk-shaped magnet 52 is attached to the interior of the first yoke 51 by the magnetic force.

A second yoke 53 formed of magnetic plates (such as iron plates) includes a bottom plate 53a with two opposite sides bent upward to form a pair of side plates 53b. The second yoke 53 is integrated with the first yoke 51 to form a closed magnetic circuit.

A box-shaped resin case 54 made of molded plastic has a circular through hole 54b in the center of a bottom wall 54a and a plurality of through holes 54c around the through hole 54b. The resin case 54 is combined with the second yoke 53 in such a way that the bottom plate 53a is exposed through the through holes 54b and 54c.

A first capacitor C1, a second capacitor C2, and a third capacitor C3 are chip capacitors placed inside the through holes 54c and are soldered, at electrodes on their bottom (not shown), to the bottom plate 53a. A chip resistor R is also placed inside one of the through holes 54c and has one electrode (not shown) soldered to the bottom plate 53a.

A disk-shaped ferrite member 55 of yttrium iron garnet (YIG) or the like is provided with a first central conductor 56, a second central conductor 57, and a third central conductor 58 formed of metal plates. The first, second, and third central conductors 56, 57, and 58 extending from a disk-shaped ground member 59 on the undersurface of the ferrite member 55, are bent toward the upper surface of the ferrite member 55, and are arranged vertically such that they partially cross one another with a dielectric (not shown) therebetween.

The first, second, and third central conductors 56, 57, and 58 have a ground portion 56a, a ground portion 57a, and a ground portion 58a, respectively, that are connected to the ground member 59. The first, second, and third central conductors 56, 57, and 58 also have a port 56b, a port 57b, and a port 58b at their respective ends.

The ferrite member 55 is placed inside the through hole 54b, while the ground member 59 is soldered to the bottom plate 53a. The ports 56b, 57b, and 58b of the first, second, and third central conductors 56, 57, and 58 are soldered to the other electrodes (not shown) of the first, second, and third capacitors C1, C2, and C3, respectively. The port 58b of the third central conductor 58 is also soldered to the other electrode (not shown) of the resistor R.

The first yoke 51 and the second yoke 53 are joined together to allow the magnet 52 to be placed on the first, second, and third central conductors 56, 57, and 58, thereby forming the known non-reciprocal circuit device (for example, see Japanese Unexamined Patent Application Publication No. 10-79607).

However, the known non-reciprocal circuit device involves cumbersome assembly work in which the ferrite member 55 provided with the first, second, and third central conductors 56, 57, and 58, and each of the first, second, and third capacitors C1, C2, and C3 must be placed in the resin case 54. This assembly work is less productive and leads to increased costs.

After the first, second, and third capacitors C1, C2, and C3 are placed in the resin case 54, the known non-reciprocal circuit device further involves a cumbersome process in which the ports 56b, 57b, and 58b of the first, second, and third central conductors 56, 57, and 58 must be soldered to the first, second, and third capacitors C1, C2, and C3, respectively, in the limited space. This assembly work is also less productive and leads to increased costs.

Moreover, the process of bending the first, second, and third central conductors 56, 57, and 58 to be wrapped around the ferrite member 55 is not only cumbersome, but also causes variations in the positions of the first, second, and third central conductors 56, 57, and 58, and leads to deterioration in performance.

A method for producing the known non-reciprocal circuit device will now be described. First, the second yoke 53 and the resin case 54 are integrated with each other. Then, each of the first, second, and third capacitors C1, C2, and C3 and the resistor R is placed in the corresponding through holes 54c of the resin case 54 and is soldered to the bottom plate 53a.

Subsequently, the ferrite member 55 provided with the first, second, and third central conductors 56, 57, and 58 is placed in the through hole 54b of the resin case 54, while the ground member 59 is soldered to the bottom plate 53a.

Then after the ports 56b, 57b, and 58b of the first, second, and third central conductors 56, 57, and 58 are soldered to the first, second, and third capacitors C1, C2, and C3, respectively, the first yoke 51 to which the magnet 2 is attached is integrated with the second yoke 53. The production of the known non-reciprocal circuit device is thus completed.

However, in the method for producing the known non-reciprocal circuit device, it is cumbersome to attach the first, second, and third central conductors 56, 57, and 58 to the ferrite member 55. Moreover, the method also involves cumbersome assembly work in which the ferrite member 55 provided with the first, second, and third central conductors 56, 57, and 58, and each of the first, second, and third capacitors C1, C2, and C3 must be placed in the resin case 54. This assembly work is less productive and leads to increased costs.

As described above, in the known non-reciprocal circuit device, there are problems in that the assembly work is cumbersome, less productive, and leads to increased costs, because it involves a process in which the ferrite member 55 provided with the first, second, and third central conductors 56, 57, and 58, and each of the first, second, and third capacitors C1, C2, and C3 must be placed in the resin case 54.

After the first, second, and third capacitors C1, C2, and C3 are placed in the resin case 54, the known non-reciprocal circuit device further involves a cumbersome process in which the ports 56b, 57b, and 58b of the first, second, and third central conductors 56, 57, and 58 must be soldered to the first, second, and third capacitors C1, C2, and C3, respectively, in the limited space. This assembly work is also less productive and leads to increased costs.

Moreover, the process of bending the first, second, and third central conductors 56, 57, and 58 to be wrapped around the ferrite member 55 is not only cumbersome, but also causes variations in the positions of the first, second, and third central conductors 56, 57, and 58, and leads to deterioration in performance.

Moreover, in the method for producing the known non-reciprocal circuit device, there are problems in that the assembly work is cumbersome, less productive, and leads to increased costs, because it not only involves a process in which the first, second, and third central conductors 56, 57, and 58 must be attached to the ferrite member 55, but also involves a process in which the ferrite member 55 with the first, second, and third central conductors 56, 57, and 58, and each of the first, second, and third capacitors C1, C2, and C3 must be placed in the resin case 54.

### SUMMARY OF THE INVENTION

Accordingly, it is an object of the present invention to provide an inexpensive and high-performance non-reciprocal circuit device that can be easily assembled and efficiently produced. It is also an object to provide a method for producing the non-reciprocal circuit device.

As a first aspect to solve the problems described above, a non-reciprocal circuit device includes a dielectric that is a multilayer board in which a plurality of insulating sheets are laminated; a first central conductor, a second central conductor, and a third central conductor that are disposed in different layers of the dielectric, and are arranged vertically such that they partially cross one another; a flat ferrite member disposed on the undersurface of the dielectric; a plurality of capacitors disposed on the undersurface of the dielectric; and a case for accommodating the ferrite member. The central conductors are formed in and integrated with the dielectric. The capacitors are secured to the undersurface of the dielectric while the ferrite member is bonded to the undersurface of the dielectric. Then, the dielectric provided with the central conductors, the ferrite member, and the capacitors are integrated to form a half-finished product, which is further integrated with the case.

When the dielectric including the central conductors, the ferrite member, and the capacitors are integrated together to form the half-finished product, which is further integrated with the case, the assembly work is easier and more productive than that of the known non-reciprocal circuit device and thus, a less expensive non-reciprocal circuit device can be achieved.

Moreover, since the capacitors can be secured to one surface of the flat dielectric outside the case, the installation work is easier and more productive than that of the known non-reciprocal circuit device and thus, a less expensive non-reciprocal circuit device can be achieved.

Since the central conductors are disposed between layers of the dielectric, variations in the positions of the central conductors are reduced and the performance of the non-reciprocal circuit device is improved compared to the case of the known non-reciprocal circuit device in which the central conductors are bent.

As a second aspect, each central conductor includes a ground portion connected to a yoke formed of metal plates constituting a part of the case, and a port connected to an electrode of one of the capacitors. The electrode of the capacitor is soldered to the port on the undersurface of the dielectric, and the capacitor is secured to the dielectric. Thus, an easy-to-assemble non-reciprocal circuit device can be achieved, as the ground portion and the capacitor can be connected to the yoke while the half-finished product is placed in the case.

As a third aspect, a connecting conductor formed in a through hole of the dielectric and in a groove of the ferrite member allows the ground portion of the central conductor to be led to the yoke. The connecting conductor is connected to the yoke by soldering. Thus, since the ground portion can be easily led to the yoke, an easy-to-assemble non-reciprocal circuit device can be achieved.

As a fourth aspect, the other electrode of the capacitor is soldered to the yoke. A resin case constituting a part of the case is provided with terminals. With the half-finished product being placed in the case, the ports of the central conductors are soldered to the terminals. Thus, an easy-to-assemble non-reciprocal circuit device can be achieved, as the ports can be easily connected to the terminals.

As a fifth aspect, the yoke is provided with a plurality of projections in locations other than the area for the ferrite member, and the other electrodes of the capacitors are connected to the top of the projections. Thus, an easy-to-assemble non-reciprocal circuit device can be achieved as the capacitors can be easily connected to the yoke.

### BRIEF DESCRIPTION OF THE DRAWINGS

FIG. 1 is a cross-sectional view showing the connection of capacitors according to a non-reciprocal circuit device of the present invention.

FIG. 2 is a plan view showing the non-reciprocal circuit device of the present invention from which a first yoke and a magnet are removed.

FIG. 3 is a cross-sectional view showing the connection of ground portions of central conductors according to the non-reciprocal circuit device of the present invention.

FIG. 4 is an exploded perspective view showing the non-reciprocal circuit device of the present invention.

FIG. 5 is a plan view showing a second yoke according to the non-reciprocal circuit device of the present invention.

FIG. 6 is a plan view showing a dielectric according to the non-reciprocal circuit device of the present invention.

FIG. 7 is a bottom view showing the dielectric according to the non-reciprocal circuit device of the present invention.

FIG. 8 is a plan view showing a main part of a large dielectric, and illustrates a method for producing the non-reciprocal circuit device of the present invention.

FIG. 9 is a plan view showing a main part of the large dielectric to which capacitors and resistors are attached, and illustrates the method for producing the non-reciprocal circuit device of the present invention.

FIG. 10 is a plan view showing a main part of the large dielectric to which ferrite members are attached, and illustrates the method for producing the non-reciprocal circuit device of the present invention.

FIG. 11 is a cross-sectional view showing the second yoke provided with solder cream, and illustrates the method for producing the non-reciprocal circuit device of the present invention.

FIG. 12 is a cross-sectional view showing a case to which a half-finished product is attached, and illustrates the method for producing the non-reciprocal circuit device of the present invention.

FIG. 13 is a cross-sectional view showing the case to which the first yoke and the magnet are attached, and illustrates the method for producing the non-reciprocal circuit device of the present invention.

FIG. 14 is an exploded perspective view showing the known non-reciprocal circuit device.

### DESCRIPTION OF THE PREFERRED EMBODIMENTS

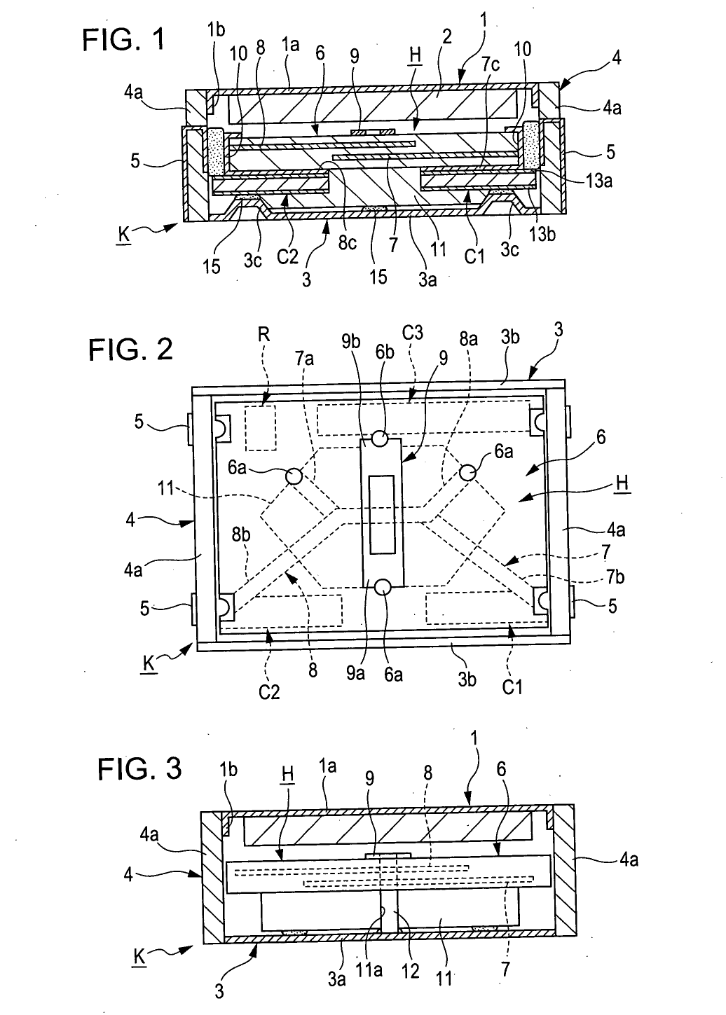

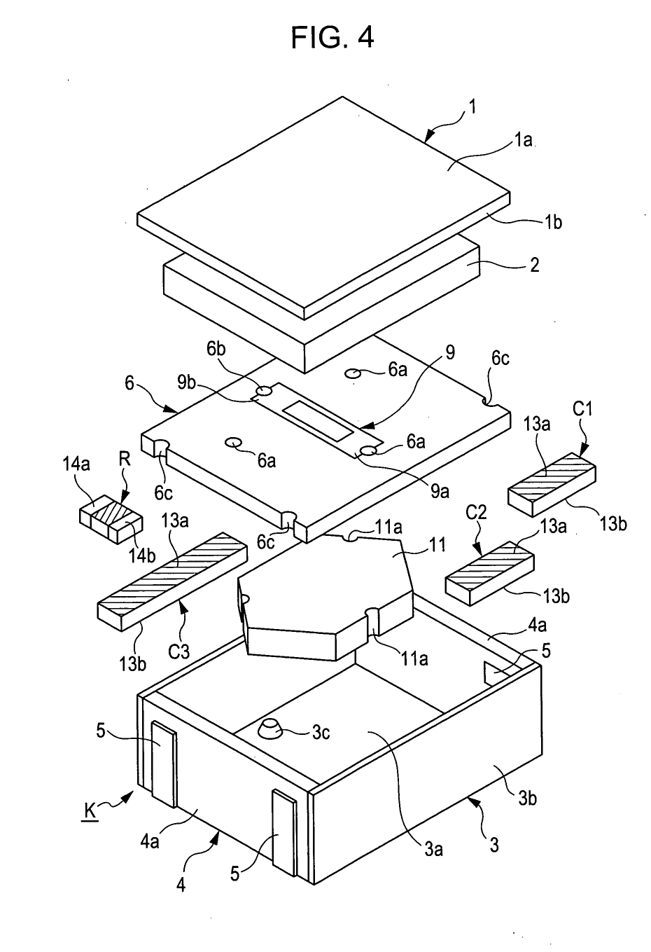

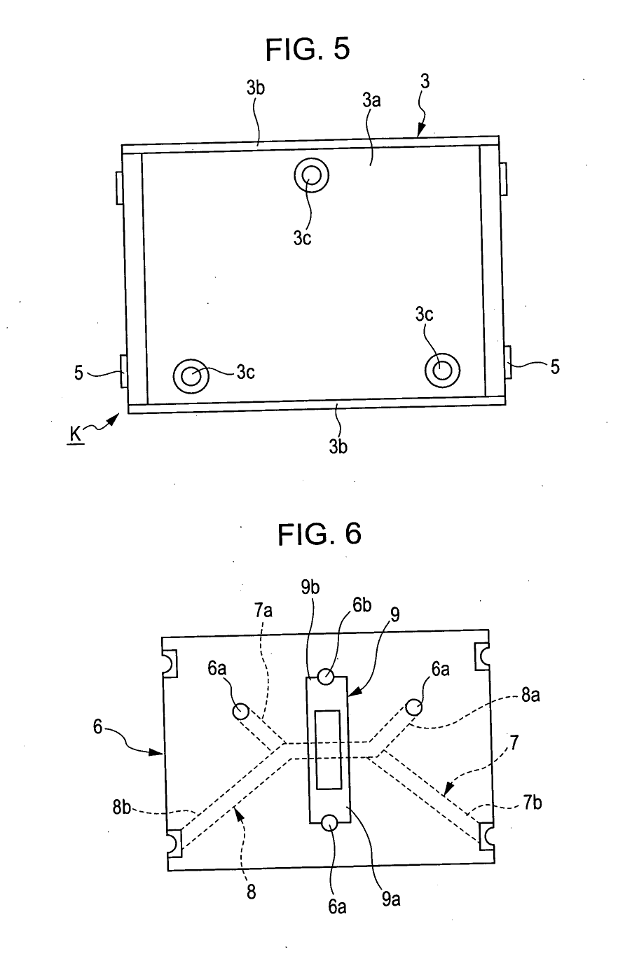

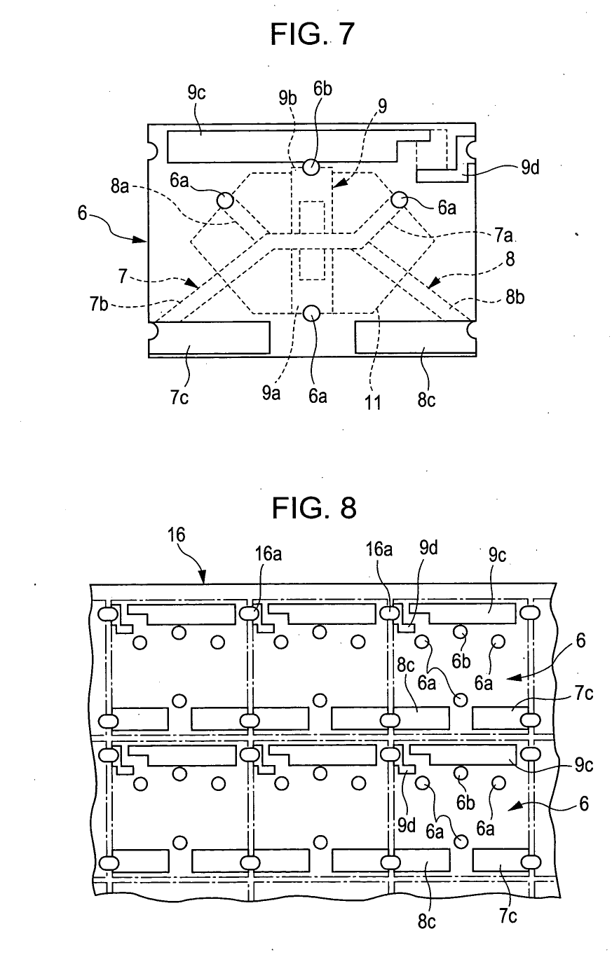

The structure of the non-reciprocal circuit device of the present invention applied to an isolator will now be described with reference to FIGS. 1 to 8. A box-shaped first yoke 1 formed of magnetic plates (such as iron plates) includes a square (rectangular) upper plate 1a and side plates 1b formed by bending the four sides of the upper plate 1a in the downward direction.

A rectangular magnet 2, with its upper surface being in contact with the inner surface of the upper plate 1a, is attached to the first yoke 1 with an adhesive or the like.

A second yoke 3 formed of magnetic plates (such as iron plates) includes a rectangular bottom plate 3a, two side plates 3b formed by bending two opposite sides of the bottom plate 3a in the upward direction, and a plurality of truncated-cone-shaped projections 3c on the bottom plate 3a, each projection 3c having a flat surface on top.

A resin case 4 made of molded plastic includes a pair of side plates 4a located between the pair of side plates 3b. The resin case 4 and the second yoke 3 are joined together to form a box-shaped case K. Metal plates are embedded in the side plates 4a of the resin case 4 to provide a plurality of terminals 5.

A rectangular dielectric 6 is a multilayer board in which a plurality of insulating sheets, such as insulating films, are laminated. A first central conductor 7, a second central conductor 8, and a third central conductor 9 are, for example, metal sheets and conductive films made of copper or the like, and are disposed in different layers of the dielectric 6. The first, second, and third central conductors 7, 8, and 9 are arranged vertically such that they partially cross one another, with the dielectric 6 interposed therebetween.

The dielectric 6 is provided with three first through-holes 6a arranged to be located at three corners of a triangle, a second through-hole 6b located between two of the three first through-holes 6a, and a plurality of grooves 6c located at side edges that are opposite each other.

The first, second, and third central conductors 7, 8, and 9 have a ground portion 7a, a ground portion 8a, and a ground portion 9a, respectively, at their respective ends. The ground portions 7a, 8a, and 9a are exposed to the interiors of the first through-holes 6a.

The first, second, and third central conductors 7, 8, and 9 have a port 7b, a port 8b, and a port 9b, respectively, at their respective ends. The ports 7b and 8b are exposed to the interiors of the grooves 6c, while the port 9b is exposed to the interior of the second through-hole 6b.

A conductor 7c, a conductor 8c, and a conductor 9c constituting a part of the ports 7b, 8b, and 9b are disposed on the undersurface of the dielectric 6. The conductors 7c, 8c, and 9c are connected via connectors (through holes) 10 provided at the positions of the grooves 6c and the second through-hole 6b.

Another conductor 9d is provided near the conductor 9c.

A flat polygonal (hexagonal) ferrite member 11 made of YIG or the like has three grooves 11a, each provided at every other side. The upper surface of the ferrite member 11 is bonded, with an adhesive or the like, to the center of the undersurface of the dielectric 6. When the ferrite member 11 is bonded, the three grooves 11a match the corresponding first through-holes 6a. Connecting conductors (through holes) 12 provided inside the grooves 11a and the first through-holes 6a allow ground portions 7a, 8a, and 9a to be led to the lower end of the ferrite member 11.

A first capacitor C1, a second capacitor C2, and a third capacitor C3 are chip capacitors. Electrodes 13a on the upper surfaces of the first, second, and third capacitors C1, C2, and C3 are soldered, connected, and secured to the conductors 7c, 8c, and 9c, respectively. At the same time, one electrode 14a of a chip resistor R is soldered, connected, and secured to the conductor 9c, while the other electrode 14b of the resistor R is soldered, connected, and secured to the conductor 9d.

Although not shown here, the other electrode 13b of the third capacitor C3 and the other electrode 14b of the resistor R are connected to each other.

Then, the dielectric 6 including the first, second, and third central conductors 7, 8, and 9, the ferrite member 11, and at least the first, second, and third capacitors C1, C2, and C3 are integrated together to form a half-finished product H. The half-finished product H is placed in and further integrated with the case K.

To integrate the half-finished product H with the case K, solder members 15, such as solder cream, are first placed on the bottom plate 3a opposite the connecting conductors 12, and on top of the projections 3c. Thus, the connecting conductors 12 are connected with the solder members 15 to the bottom plate 3a, the ground portions 7a, 8a, and 9a of the first, second, and third central conductors 7, 8, and 9 are grounded, and the electrodes 13b on the undersurfaces of the first, second, and third capacitors C1, C2, and C3 are connected with the solder members 15 to the top of the projections 3c and grounded.

When, as described above, the electrodes 13b on the undersurfaces of the first, second, and third capacitors C1, C2, and C3 are designed to be placed on top of the projections 3c, the undersurfaces of the first, second, and third capacitors C1, C2, and C3 can be brought close to the projections 3c when integrated as a part of the half-finished product H with the case K, since each of the first, second, and third capacitors C1, C2, and C3 has a thickness smaller than that of the ferrite member 11.

Furthermore, the ports 7b and 8b of the first and second central conductors 7 and 8 are soldered to the terminals 5, while the conductor 9d connected to the resistor R adjacent to the third central conductor 9 is soldered to the terminal 5 for making a connection to the ground.

With the magnet 2, the dielectric 6, and the ferrite member 11 interposed, the first yoke 1 and the second yoke 3 are joined together to form a closed magnetic circuit, thereby forming the non-reciprocal circuit device of the present invention.

A method for producing the non-reciprocal circuit device of the present invention will now be described with reference to FIGS. 8 to 13. As shown in FIG. 8, the plurality of dielectrics 6, each being a multilayer board in which a plurality of insulating sheets are laminated, are arranged and connected together to form a large dielectric 16 for implementing a plurality of non-reciprocal circuit devices. The large dielectric 16 is provided with the first, second, and third central conductors 7, 8, and 9 (not shown) disposed in different layers of each dielectric 6; the first through-holes 6a and second through-hole 6b corresponding to each dielectric 6; a plurality of holes 16a across the boundaries of adjacent dielectrics 6; the conductors 7c, 8c, and 9c, on one surface of the large dielectric 16, that constitute a part of the ports 7b, 8b, and 9b in each dielectric 6; and the conductor 9d of each dielectric 6.

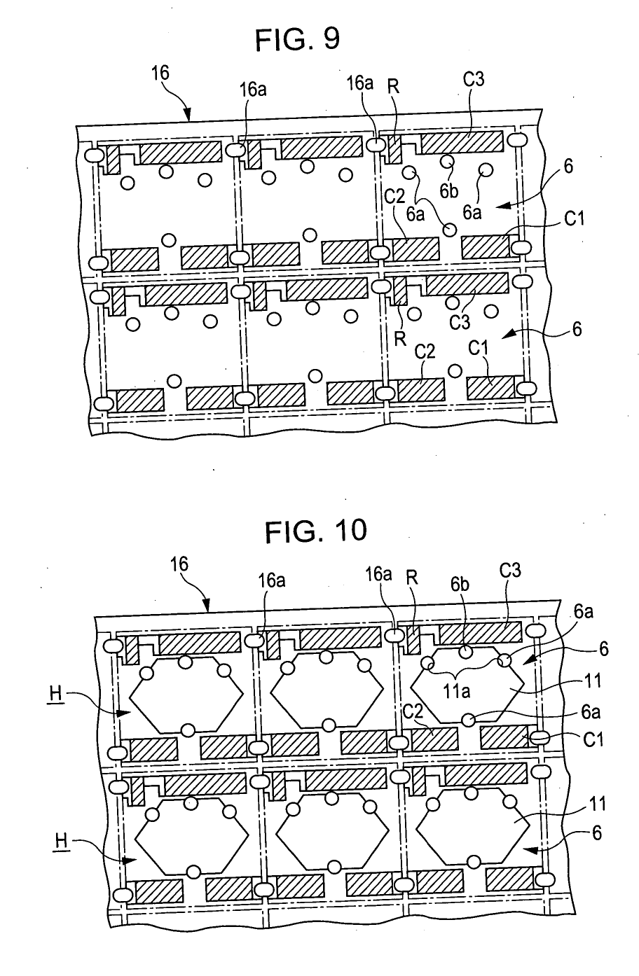

Subsequently, as shown in FIG. 9, the first, second, and third capacitors C1, C2, and C3 and the resistor R corresponding to each dielectric 6 are soldered to the conductors 7c, 8c, 9c, and 9d, respectively, to be secured to the large dielectric 16.

Then, after the insertion of pin jigs (not shown) into the first through-holes 6a, with the grooves 11a of the ferrite member 11 corresponding to each dielectric 6 being aligned with the pin jigs, the ferrite member 11 is bonded to one surface of the large dielectric 16.

An adhesive is applied to one surface of the ferrite member 11 and/or to one surface of the large dielectric 16.

Although the bonding process for the ferrite member 11 is performed after the securing process for the capacitors in the present embodiment, the bonding process for the ferrite member 11 may be performed before the securing process for the capacitors.

Although not shown here, the connecting conductors 12 are provided inside the first through-holes 6a and the grooves 11a to allow the ground portions 7a, 8a, and 9a of the first, second, and third central conductors 7, 8, and 9, respectively, to be led to an end of the ferrite member 11. In addition, the connectors 10 are provided inside the holes 16a and the second holes 6b to connect the conductors 7c, 8c, and 9c to the first, second, and third central conductors 7, 8, and 9, respectively.

Subsequently, the large dielectric 16 is separated, along the boundaries between adjacent dielectrics 6, into individual dielectrics 6. Then, each dielectric 6 including the first, second, and third central conductors 7, 8, and 9; the ferrite member 11; and the first, second, and third capacitors C1, C2, and C3 are integrated to form the half-finished product H.

Since the large dielectric 16 is cut off at the positions of the holes 16a, the grooves 6c are formed on the side edges of the dielectric 6.

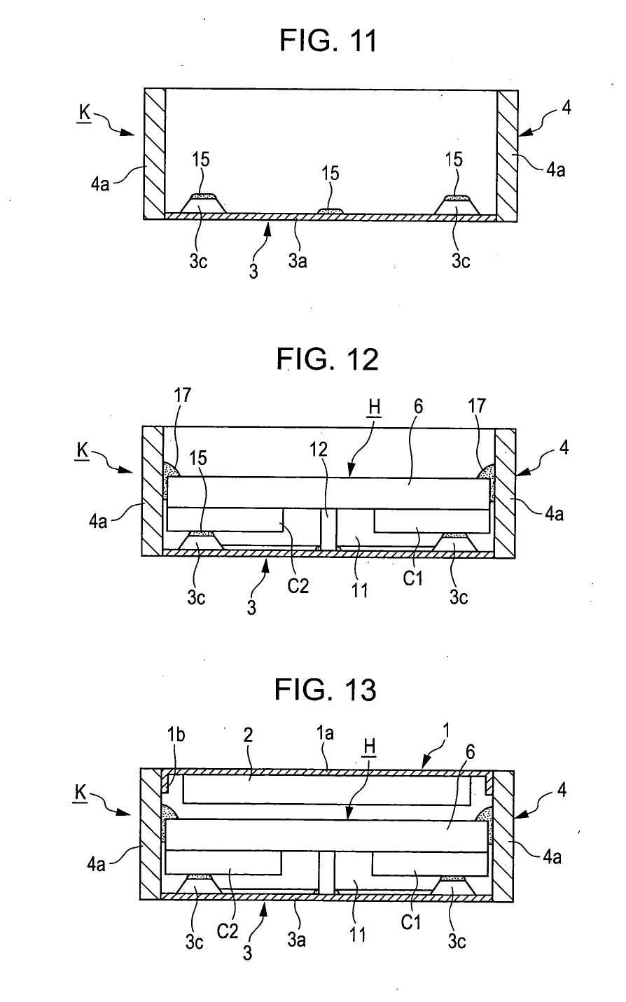

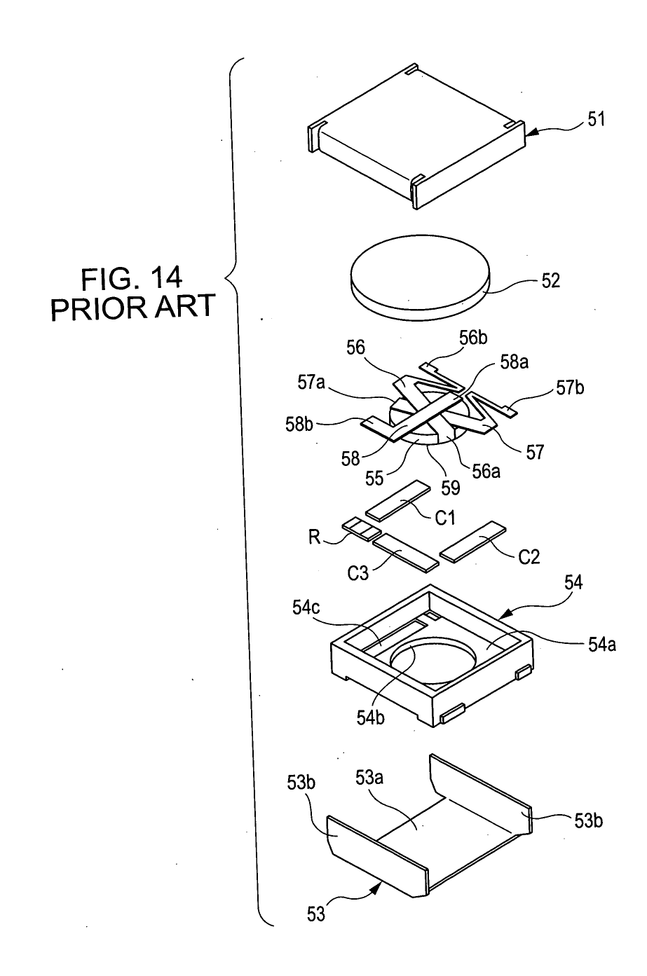

Then, as shown in FIG. 11, the solder members 15, such as solder cream, are placed on the bottom plate 3a of the second yoke 3 in the case K and on top of the projections 3c. Subsequently, as shown in FIG. 12, the half-finished product H is placed in the case K, while the connecting conductors 12 and the first, second, and third capacitors C1, C2, and C3 are placed on the solder members 15. Moreover, solder cream 17 is placed between the ports 7b and 8b and the terminals 5, and between the conductor 9d and the terminal 5.

In this state, the case K including the half-finished product H is placed in a reflow furnace for soldering between the connecting conductors 12 and the bottom plate 3a, between the first, second, and third capacitors C1, C2, and C3 and their corresponding projections 3c, and between the ports 7b, 8b, and 9b and their corresponding terminals 5. After soldering, as shown in FIG. 13, the first yoke 1 to which the magnet 2 is attached is integrated with the case K to complete the production of the non-reciprocal circuit device of the present invention.

Soldering between the half-finished product H and the second yoke 3, and between the half-finished product H and the terminals 5 may be performed in separate steps.

Although the non-reciprocal circuit device of the present invention is applied to an isolator in the embodiment described above, the resistor R may be removed from the non-reciprocal circuit device, which can then be applied to a circulator.

1. A non-reciprocal circuit device comprising a dielectric that is a multilayer board in which a plurality of insulating sheets are laminated; a first central conductor, a second central conductor, and a third central conductor that are disposed in different layers of the dielectric, and are arranged vertically such that the first, second and third central conductors partially cross one another; a flat ferrite member disposed on the undersurface of the dielectric; a plurality of capacitors disposed on the undersurface of the dielectric; and a case for accommodating the ferrite member; wherein the central conductors are formed in and integrated with the dielectric; the capacitors are secured to the undersurface of the dielectric while the ferrite member is bonded to the undersurface of the dielectric; and the dielectric provided with the central conductors, the ferrite member, and the capacitors are integrated to form a half-finished product, which is integrated with the case.

2. The non-reciprocal circuit device according to claim 1, wherein each central conductor comprises a ground portion connected to a yoke formed of metal plates constituting a part of the case, and a port connected to an electrode of one of the capacitors; the electrode of the capacitor is soldered to the port on the undersurface of the dielectric; and the capacitor is secured to the dielectric.

3. The non-reciprocal circuit device according to claim 2, wherein a connecting conductor formed in a through hole of the dielectric and in a groove of the ferrite member allows the ground portion of each central conductor to be led to the yoke, and the connecting conductor is connected to the yoke by soldering.

4. The non-reciprocal circuit device according to claim 2, wherein other electrodes of the capacitors are soldered to the yoke; a resin case constituting a part of the case is provided with terminals; and, with the half-finished product being placed in the case, the ports of the central conductors are soldered to the terminals.

5. The non-reciprocal circuit device according to claim 4, wherein the yoke is provided with a plurality of projections in locations other than an area for the ferrite member, and the other electrodes of the capacitors are connected to a top of the projections.
